(19) United States
(12) Patent Application Publication
(10) Pub. No.: US 2011/0318077 A1
(43) Pub. Date: Dec. 29, 2011

(54) HEAT-PRODUCING ELEMENT FOR FIXING DEVICE AND IMAGE FORMING APPARATUS

(75) Inventors: Izumi MUKOYAMA, Tokyo (JP); Akira OHIRA, Tokyo (JP); Susumu SUDO, Tokyo (JP); Eiichi YOSHIDA, Tokyo (JP)

(73) Assignee: KONICA MINOLTA BUSINESS TECHNOLOGIES, INC., Tokyo (JP)

(21) Appl. No.: 13/161,075

(22) Filed: Jun. 15, 2011

(30) Foreign Application Priority Data
Jun. 24, 2010 (JP) 2010-143423

(51) Int. Cl. G03G 15/20

(52) U.S. Cl. 399/333

(57) ABSTRACT

A heat-producing element for fixing a toner image on an image support, in which the heat-producing element comprises a heat-resistant resin and electrically-conductive fiber having a shape stipulated by conditions 1, 2 and 3.
1. Aspect ratio: 0.025≦(A/B)≦0.25
2. Diameter of electrically-conductive fiber (A): 0.5 μm≦A≦3 0 μm
3. Length of electrically-conductive fiber (B): 5.0 μm≦B≦1,000 μm

This application is based on Japanese Patent Application No. 2010-143423 filed on Jun. 24, 2010, in Japanese Patent Office, the entire content of which is hereby incorporated by reference.

### TECHNICAL HELD

The present invention relates to a heat-producing element for a fixing device and an image forming apparatus using the same.

### BACKGROUND

Conventionally, in image forming apparatuses such as copiers and laser beam printers, a method, in which after toner development, an unfixed toner image having been transferred on an image support such as plain paper is subjected to contact heating fixing using a heat roller system, has been used in many cases.

However, in such a heat roller system, it takes long time to achieve the fixable temperature by heating and also a large amount of heating energy is required. From the viewpoint of shortening of the time from power activation to copy start (the warming-up time) and energy saving, recently, a heat film fixing system has become mainstream.

In a fixing device (fixing unit) of this heat film fixing system, a seamless fixing belt, in which a releasable layer such as a fluorine resin is laminated on the outer surface of a heat-resistant film such as polyimide, is used.

Incidentally, in a fixing device of such a heat film fixing system, since a film is heated, for example, via a ceramic heater and then a toner image is fixed on the film surface, the thermal conductivity of the film becomes a critical point. However, when the fixing belt film is allowed to be thinner to improve the thermal conductivity, mechanical strength tends to decrease and then it becomes difficult to realize high-speed rotation, whereby formation of a high quality image at high speed becomes problematic and also such a problem that the ceramic heater is liable to break is produced.

To solve such problems, recently, a method has been proposed in which a fixing belt itself is provided with a heat-producing body and then the heat-producing body is fed, whereby the fixing belt is directly heated to fix a toner image. In an image forming apparatus of this system, warming-up time is shortened and power consumption is further reduced. Therefore, as a heat fixing device, excellence is expressed from the viewpoint of energy saving and speeding up.

Such a technology includes the following: for example, a heat-producing body constituted of a conductive material such as conductive ceramic, conductive carbon, or metal powder and an insulating material such as insulating ceramic or a heat-resistant resin (Parent Document 1), a heat-producing element having a heat-producing layer in which a carbon nanomaterial and filament-shaped metal fine particles are dispersed in a polyimide resin, as well as having an insulating layer and a releasing layer (Patent Document 2), and a technology in which a fixing device employs a heat-producing element featuring positive temperature characteristics; and a heat-producing layer is formed of a conductive oxide and can also be formed by mixing the oxide and a resin (Patent Document 3).

### PRIOR ART DOCUMENTS

### Patent Documents

Patent Document 1: Unexamined Japanese Patent Application Publication (hereinafter referred to as JP-A) No. 2004-281123
Patent Document 2: JP-A No. 2007-272223
Patent Document 3: JP-A No. 2006-350241

### SUMMARY OF THE INVENTION

### Problems to be Solved by the Invention

The technological development of a fixing device employing a heat-producing element is being actively conducted as described above. However, a metallic filler such as copper, nickel, or silver enabling to efficiently realize resistance reduction of the heat-producing element produces some sort of a problem such as resistance increase via oxidation, safety, and high cost, whereby adequate performance as a heat-producing element cannot be maintained for a long term. Therefore, it has not been realized to develop a fixing device employing a heat-producing element having an advantage of such as the reduced warming-up time and energy saving performance.

The present invention was completed to solve the above problems.

An object of the present invention is to provide a heat-producing fixing belt in which the resistance of a heat-producing element can be efficiently reduced, high performance can be maintained for a long term, and energy saving can be realized due to reduced warming-up time and energy saving performance; and an image forming apparatus using the same.

### Means to Solve the Problems

The inventors of the present invention focused on a resistance reduction effect in the case of use of fiber of metals, graphite and the like which is inexpensive and stable as a substance and then investigated the possibility of practical use thereof. The fiber of metals, graphite and the like are extremely stable at a temperature range of 100 to 200° C. which is employed for a fixing belt. Further, since graphite contains nothing but carbon, no problem is noted either from the safety point of view, and no cost problem is produced either. However, the problem that the resistance is not reduced as mush as metallic filler such as copper or nickel by spherical or flat shape graphite has remained.

However, it was found that when fibrous filler satisfying specific requirements is used, resistance reduction was realized equivalently to metallic filler such as silver or nickel. The reason is presumed to reduce resistance since the fibrous filler forms conductive paths in the heat producing layer with no discontinuity compared with the conventional spherical conductive material, however, the direct contact of filler each other is few and therefore adequate resistance reduction was realized. The present invention was completed via further repeated investigations based on these findings.

It was found that an object of the present invention was able to be achieved employing the following constitution:

(1) A heat-producing element for fixing a toner image on an image support, wherein the heat-producing element comprises a heat-resistant resin and electrically-conductive fiber having a shape stipulated by conditions 1, 2 and 3 described below.
1. Aspect ratio: 0.025≦(A/B)≦0.25
2. Diameter of electrically-conductive fiber (A): 0.5 μm≦A≦3 0 μm
3. Length of electrically-conductive fiber (B): 5.0 μm≦B≦1,000 μm

(2) The heat-producing element for a fixing device, described in item (1), in which the heat-resistant resin comprises a polyimide resin.

(3) The heat-producing element for a fixing device, described in item (1), in which the electrically-conductive fiber is metallic fiber and the heat-resistant resin is a polyimide resin.

(4) The heat-producing element for a fixing device, described in item (1), in which the electrically-conductive fiber is fiber of graphite and the heat-resistant resin is a polyimide resin.

(5) The heat-producing element for a fixing device, described in item (2), in which a content of the electrically-conductive fiber is from 5.0% to 60% by volume with respect to the polyimide resin.

(6) A heat-producing element for fixing a toner image on an image support comprising a heat-resistant resin support and, provided thereon, a heat-producing layer, wherein the heat-producing layer comprises a heat-resistant resin and electrically-conductive fiber having a shape stipulated by conditions 1, 2 and 3 described below.
1. Aspect ratio: 0.025≦(A/B)≦0.25
2. Diameter of electrically-conductive fiber (A): 0.5 μm≦A≦3 0 μm
3. Length of electrically-conductive fiber (B): 5.0 μm≦B≦1,000 μm

(7) In an image forming apparatus in which after uniform charging of an electrophotographic photoreceptor, a toner image having been formed using an image exposure member and a toner developing member is transferred on an image support and then fixed using a heat fixing member, an image forming apparatus using the heat-producing element for a fixing device described in any of items (1) to (5) as the heat fixing member.

The present invention makes it possible to provide a heat-producing fixing belt in which the resistance of a heat-producing element can be efficiently reduced, sufficient performance can be maintained for a long term, and energy saving can be realized due to reduced warming-up time; and an image forming apparatus using the same.

### BRIEF DESCRIPTION OF THE DRAWINGS

FIG. 1 is a constitutional sectional view showing the constitution of a typical heat-producing element of the present invention;

FIG. 2 is a constitutional schematic view of a fixing device incorporating a heat-producing element of the present invention;

FIG. 3 is a sectional constitutional view showing one example of an image forming apparatus of the present invention.

### PREFERRED EMBODIMENTS OF THE INVENTION

The present invention, materials to be used, and an image forming apparatus will now further be described.

In the conventional fixing device, a heat-producing element for a fixing device in which a carbon nanomaterial or filament-shaped metal fine particles are dispersed in a polyimide resin and a heat-producing element containing a conductive oxide have been proposed. However, to coordinate the heat-producing layer of a heat-producing element for the appropriate electrical resistivity, a large amount of a compound is added, whereby the problems that the strength of the heat-producing layer is decreased and durability is degraded have been produced.

The feature of the present invention is that an electrically-conductive material, which has an electrical specific resistance close to that of metal as a conductive material, is hard to oxide compared with copper, and is more inexpensive than silver and gold, resulting in use in a wide range of applications, is used as a conductive material to constitute a heat-producing layer, and thereby a heat-producing element satisfying the appropriate electrical resistance and temperature-rising characteristics and exhibiting enhanced durability has been provided.

The feature of the present invention is that the heat-producing element comprises electrically-conductive fiber having an aspect ratio of 0.025 to 0.25, diameter of 0.5 μm to 30 μm, and a length of 5.0 μm to 1,000 μm incorporated in a resin such as polyimide. The aspect ratio is preferably 0.04 to 0.23.

The present invention has realized a heat-producing element exhibiting low resistance and uniformity basically using one type of conductive fiber as an electrically-conductive material forming the heat-producing layer to attain the targeted resistance. The electrically-conductive fiber can be employed incorporated in the resin at 5.0% by volume to 60% by volume, and these embodiments can be considered to be preferred examples of the present invention.

Heat-Producing Element for Fixing Device

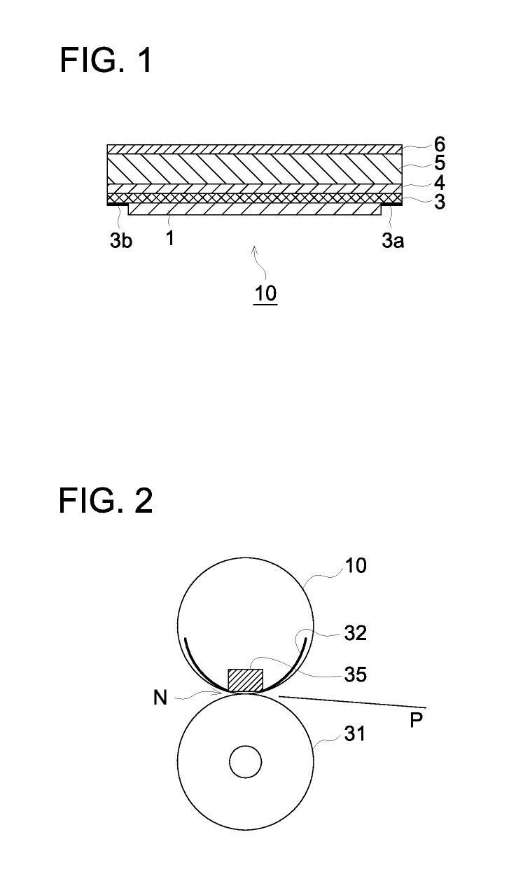

FIG. 1 is a constitutional sectional view showing the configuration of a typical heat-producing element of the present invention.

In a heat-producing element 10, the support 1 is formed of a heat-resistant resin such as polyimide. Thereon, a heat-producing layer whose end portions are provided with power supplying terminals 3a and 3b is coated and then via an insulating resin layer 4, an elastic body layer 5 and further a releasing layer 6 serving as the surface layer are provided. However, this represents a typical layer configuration. In the present invention, with regard to the layer constitution, any constitution may be employed as long as the constitution realizes a heat-producing element having a heat-producing layer 3 in which a thin leaf graphite-pulverized material is incorporated in a heat-resistant resin as a conductive material. A thickness of the heat-producing element as a whole is preferably 200 to 600 μm. A thickness of the heat-producing layer is preferably 50 to 200 μm, and more preferably 70 to 200 μm. A thickness of the elastic body layer is preferably 100 to 300 μm. A thickness of the releasing layer is preferably 5 to 30 μm. A thickness of the insulating resin layer is preferably 5 to 30 μm.

The heat-producing element of the present invention may have any shape such as a belt shape and a pipe shape according to the use methods in an image forming apparatus.

With regard to the production method therefor, a common method is also employable.

Specific volume resistance of the heat-producing layer containing electrically-conductive material having a diameter of 0.5 μm to 30 μm, length of 5.0 μm to 1,000 μm and an aspect ratio of from 0.025 to 0.25 in the heat-resistant resin can be obtained by measuring resistance value between electrodes which are provided by conductive tape in whole circumferential direction of both ends of the heat-producing element, and then calculating by the following formula.

Specific volume resistance (ρ)=(R·d·W)/L(Ω·m)

(herein, resistance value (R: Ω), thickness of the heat-producing layer (d: m), length in circumferential direction (W: m), length between the electrodes (L: m))

Specific volume resistance of the heat-producing layer is preferably from 8×10⁻⁶ to 1×10⁻²Ω·m.

FIG. 2 shows a constitutional schematic view of a fixing device incorporating a heat-producing element of the present invention. The heat-producing element 10 is pressed against an opposed pressure roller 31 by a pressure member 35. N represents the nip portion produced by the heat-producing element 10 having been pressed by the pressure member 35 and the pressure roller 31. The symbol 32 represents the guide member of the heat-producing element 10. The heat-producing element 10 is usually supported from inside by a roller for supporting and conveying, which is not shown in FIG. 2.

An image support P on which an unfixed toner image has been placed is passed through this nip portion and conveyed, whereby the toner image is fixed on the image support P.

Electrically-Conductive Fiber

An electrically-conductive fiber used in the invention includes representatively pure metallic fiber, such as gold, silver, iron and aluminum, metal alloy fiber such as stainless steel, nichrome, and non metallic fiber such as graphite. The term of fiber means a material having shape of thread.

The fiber can be manufactured by a conventional method. For example, first, a material is withdrawn from a nozzle to make fiber shapes, which may be expanded if necessary to make thinner, and further may be subjected to heating in this instance if necessary, and electrically-conductive fiber having targeted diameter (A). The targeted electrically-conductive fiber is obtained by cutting the obtained electrically-conductive fiber into predetermined length (B).

Volume specific resistance of the electrically-conductive fiber as itself is not more than 10⁻¹Ω·m. A heat-producing body is prepared by incorporating the electrically-conductive fiber in the heat-resistant resin, and the heat-producing element for a fixing device is manufactured by employing the heat-producing body.

Volume specific resistance is obtained by applying predetermined current I (A) to cross-sectional area W×t, and measuring potential difference V (V) between electrodes separated by a distance L.

Specific volume resistance ρv=VWt/IL

Diameter of electrically-conductive fiber (A) is 0.5 μm to 30 μm, length of fiber (B) is 5.0 μm to 1,000 μm, and an aspect ratio is 0.025 to 0.25 for obtaining effects of the present invention.

The values A and B of the fiber are defined by an average of 500 or more samples.

Photograph of electrically-conductive fiber was took via scanning electron microscope with 500 time magnitude, which was introduced by a scanner, and diameter and length of at least 500 fibers were measured and average value was calculated. The aspect ratio was obtained by dividing diameter by length of the fiber (A/B).

The fibers distributed in the conductive layer are in contact with each other and contact resistance becomes in excess whereby sufficient low resistivity is not obtained in the heat-producing layer as a whole when the diameter of the fiber is not more than 0.5 μm. When the diameter of the fiber is more than 30 μm, sufficient dispersibility of the fiber in the heat-producing layer is not obtained and resistivity varies locally. In the case of length of fiber of less than 5.0 μm, conduction paths are hard to form and resistivity is hard to reduce in some cases, and when the length excesses 1,000 μm the fiber cannot be remained in an extended shape, and generates local variation of resistivity. Further, inconvenience described above may appear when the aspect ratio is less than 0.025 or more than 0.25.

Heat-Resistant Resin

A heat-resistant resin is used for a binder resin forming the heat-producing layer. In general, those having a short-term heat resistance of at least 200° C. and a long-term heat resistance of at least 150° C. are referred to as heat-resistant resins. Such typical heat-resistant resins are listed as described below.

These are polyphenylene sulfide, polyarylate, polysulfone, polyethersulfone, polyetherimide, polyimide, and polyetheretherketone resins. Polyimide resin is particularly preferable.

Any of these is mixed with an electrically-conductive fiber such as graphite or metal and used as a low resistance heat-producing layer, as well as being used as a constituent resin of other layers.

In the present invention, it is extremely preferable that above described resin occupies at least 40% by volume of the entire resin amount.

Heat is produced by supplying electric power, through, for example terminals provided at the end portion of the heat producing element. Power is controlled in accordance with the resistance of the heat producing element, applied voltage, fixing line speed and so on.

Image Forming Apparatus

For the image forming apparatus of the present invention, a commonly structured one is employable except the fixing device.

A typical apparatus will now be described.

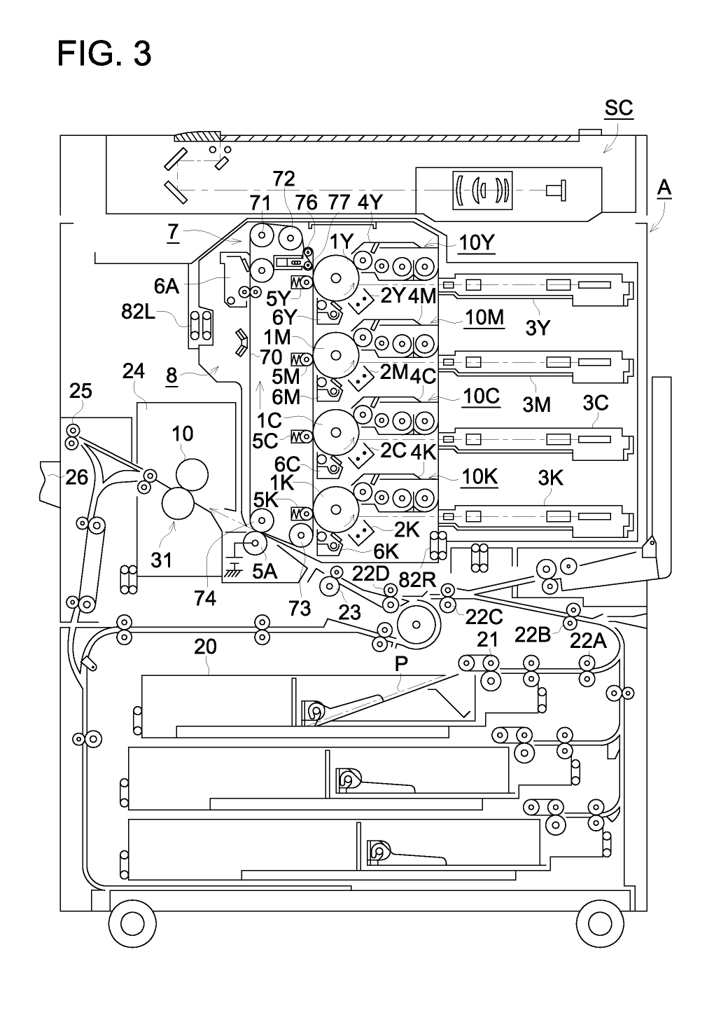

In FIG. 3, 1Y, 1M, 1C, and 1K represent photoreceptors and 4Y, 4M, 4C, and 4K represent developing devices; 5Y, 5M, 5C, and 5K represent primary transfer rollers as primary transfer members and 5A represents a secondary transfer roller as a secondary transfer member; and 6Y, 6M, 6C, and 6K represent cleaning devices. And then, 7, 24, and 70 represent an intermediate transfer body unit, a heat roller-system fixing device, and an intermediate transfer body, respectively.

This image forming apparatus is referred to as a tandem-type image forming apparatus, which is provided with plural sets of image forming sections 10Y, 10M, 10C, and 10K, an endless belt-shaped intermediate transfer body unit 7 serving as a transfer section, an endless belt-shaped sheet feed/conveyance member 21 to convey an image support P, and a heat-producing element-system fixing device serving as a fixing member. On top of the main body A of the image forming apparatus, an original image reading apparatus SC is arranged.

The image forming section 10Y to form a yellow image as one of the toner images of different color formed on each photoreceptor has a drum-shaped photoreceptor 1Y as a first photoreceptor, as well as a charging member 2Y, an exposure member 3Y, a developing member 4Y, a primary transfer roller 5Y as a primary transfer member, and a cleaning member 6Y arranged in the periphery of the photoreceptor drum 1Y. Further, the image forming section 10M to form a magenta image as another one of the toner images of different color has a drum-shaped photoreceptor 1M as a first photoreceptor, as well as a charging member 2M, an exposure member 3M, a developing member 4M, a primary transfer roller 5M as a primary transfer member, and a cleaning member 6M arranged in the periphery of the photoreceptor drum 1M.

Still further, the image forming section 10C to form a cyan image as another one of the toner images of different color has a drum-shaped photoreceptor 1C as a first photoreceptor, as well as a charging member 2C, an exposure member 3C, a developing member 4C, a primary transfer roller 5C as a primary transfer member, and a cleaning member 6C arranged in the periphery of the photoreceptor drum 1C. Furthermore, the image forming section 10K to form a black image as another one of the toner images of different color has a drum-shaped photoreceptor 1K as a first photoreceptor, as well as a charging member 2K, an exposure member 3K, a developing member 4K, a primary transfer roller 5K as a primary transfer member, and a cleaning member 6K arranged in the periphery of the photoreceptor drum 1K.

The endless belt-shaped intermediate transfer body unit 7 has an endless belt-shaped intermediate transfer body 70 as a second image carrier of an intermediate transfer endless belt shape which is wound around a plurality of rollers and rotatably supported.

Each of the color images having been formed by the image forming sections 10Y, 10M, 10C, and 10K is successively transferred onto the rotating endless belt-shaped intermediate transfer body 70 by the primary transfer rollers 5Y, 5M, 5C, and 5K to form a composed color image. An image support P such as a sheet as a transfer medium accommodated in a sheet feed cassette 20 is fed by the sheet feed/conveyance member 21, and passed through a plurality of intermediate rollers 22A, 22B, 22C, and 22D, and a registration roller 23, followed by being conveyed to a secondary transfer roller 5A serving as a secondary transfer member to collectively transfer the color images onto the image support P. The image support P, on which the color images have been transferred, is subjected to fixing treatment using the heat-producing element-system fixing device 24, and then is nipped by a sheet discharging roller 25 and placed onto a sheet discharging tray 26 outside the apparatus.

On the other hand, the color image is transferred onto the image support P by the secondary transfer roller 5A, and thereafter the residual toner on the endless belt-shaped intermediate transfer body 70, which has curvature-separated the image support P, is removed by the cleaning member 6A.

During image forming processing, the primary transfer roller 5K is always in pressure contact with the photoreceptor 1K. The other primary transfer rollers 5Y, 5M, and 5C each are brought into pressure contact with the corresponding photoreceptors 1Y, 1M, and 1C only during color image formation.

The secondary transfer roller 5A is brought into pressure contact with the endless belt-shaped intermediate transfer body 70 only when an image support P is passed at this roller position for the secondary transfer.

In this manner, toner images are formed on the photoreceptors 1Y, 1M, 1C, and 1K via charging, exposure, and development and then each of the color toner images is superimposed on the endless belt-shaped intermediate transfer body 70, followed by collective transfer thereof onto an image support P to carry out pressure and heating fixation by the fixing device 24 for fixing. With regard to the photoreceptors 1Y, 1M, 1C, and 1K from which the toner images have been transferred on the image support P, the toners having been allowed to remain on the photoreceptors during transfer are cleaned by the cleaning device 6A and thereafter, the photoreceptors enter the above cycle of charging, exposure, and development for the following image formation.

Further, as the photoreceptor, any appropriate inorganic photoreceptor or organic photoreceptor is usable.

In FIG. 3, a fixing device 24 of the heat-producing element fixing system incorporating heat-producing element 10 of the present invention and a pressure roller is used.

Image Support

An image support (referred to also as a recording medium, recording paper, or a recording sheet) enabling to form an image using a toner according to the present invention may be a commonly used one, which needs only to be one holding a toner image having been formed via an image forming method employing, for example, the above image forming apparatus. As those used as usable image supports in the present invention, there are listed, for example, plain paper, being thin to thick, bond paper, art paper, and coated printing paper such as coated paper, as well as commercially available Japanese paper and postcard paper, OHP plastic films, and cloths.

### EXAMPLES

A typical embodiment of the present invention and effects thereof will now be described to further describe the present invention.

Preparation of Coating Composition of Heat-Producing Layer

There were sufficiently mixed 100 g of polyamic acid which is a precursor of polyamide resin (U-varnish S301, produced by Ube Industries, Ltd.) and 32 g of each of various types of stainless steel fiber samples S-A to A-N described in Table 1, 16 g of each of various types of graphite fiber samples C-A to C-N described in Table 2 using a planetary stirring machine.

TABLE 1

| Heat- | | | | | |
|---|---|---|---|---|---|
| producing | Fiber | Diameter | Length | | |
| element | No. | (μm) | (μm) | Aspect ratio | Remarks |
| S-A | 1 | 0.5 | 6.0 | 0.083 | Invention |
| S-B | 2 | 1.0 | 5.0 | 0.200 | Invention |
| S-C | 3 | 8.0 | 32.0 | 0.250 | Invention |
| S-D | 4 | 15.0 | 200.0 | 0.075 | Invention |
| S-E | 5 | 15.0 | 250.0 | 0.060 | Invention |
| S-F | 6 | 15.0 | 600.0 | 0.025 | Invention |
| S-G | 7 | 28.0 | 200.0 | 0.140 | Invention |
| S-H | 8 | 30.0 | 900.0 | 0.033 | Invention |
| S-I | 10 | 0.4 | 6.0 | 0.067 | Comparative |
| S-J | 9 | 2.7 | 10.0 | 0.270 | Comparative |
| S-K | 14 | 22.0 | 950.0 | 0.023 | Comparative |
| S-L | 11 | 1.0 | 4.0 | 0.250 | Comparative |
| S-M | 13 | 32.0 | 135.0 | 0.237 | Comparative |
| S-N | 12 | 100.0 | 1100.0 | 0.091 | Comparative |

TABLE 2

| Heat- | | | | | |
|---|---|---|---|---|---|
| producing | Fiber | Diameter | Length | | |
| element | No. | (μm) | (μm) | Aspectp ratio | Remarks |
| C-A | 1 | 0.5 | 6.0 | 0.083 | Invention |
| C-B | 2 | 1.0 | 5.0 | 0.200 | Invention |
| C-C | 3 | 8.0 | 35.0 | 0.229 | Invention |
| C-D | 4 | 8.0 | 50.0 | 0.160 | Invention |
| C-E | 5 | 8.0 | 200.0 | 0.040 | Invention |
| C-F | 6 | 10.0 | 200.0 | 0.050 | Invention |
| C-G | 7 | 28.0 | 200.0 | 0.140 | Invention |
| C-H | 8 | 30.0 | 900.0 | 0.033 | Invention |
| C-I | 9 | 0.4 | 8.0 | 0.050 | Comparative |
| C-J | 14 | 28.0 | 1050.0 | 0.027 | Comparative |
| C-K | 11 | 0.5 | 25.0 | 0.020 | Comparative |
| C-L | 10 | 0.5 | 3.0 | 0.167 | Comparative |
| C-M | 13 | 10.0 | 30.0 | 0.333 | Comparative |
| C-N | 12 | 32.0 | 130.0 | 0.246 | Comparative |

Production of Heat-Producing Elements

(Pipe Support)

The heat producing elements have pipe shape in the Example, and the shape may be modified as desired.

A stainless steel pipe of an outer diameter of 30 mm and a total length of 345 mm having been previously coated with a releasing agent, FRELEASE 44, product by Neos Ca, Ltd., was coated with polyamic acid (U-varnish S301, produced by Ube Industries, Ltd.) at a film thickness of 500 μm. Thereafter, drying was carried out at 150° C. for 3 hours, and pipe support having a dry thickness of around 70 μm was formed

(Production of a Heat-Producing Layer)

On the reinforcing layer, a dope was coated at a film thickness of 500 μm. Then, drying was carried out at 150° C. for 3 hours, followed by 30-minute drying at 400° C. for imidization. Heat-Producing Layer having a dry thickness of around 100 μm was formed. Power supplying terminals were provided at the ends of the obtained pipe via an electroless nickel plating.

(Production of an Elastic Body Layer)

The polyimide resin pipe-shaped heat-producing layer fitted for the stainless pipe was coated with a primer (trade name: KE-1880, produced by Shin-Etsu Chemical Co., Ltd.), followed by drying at normal temperature for 30 minutes.

The polyimide resin pipe-shaped material was inserted into a tube of fluorine resin (trade name: GPC, produced by Gunze Ltd.) inside of which a primer (trade name: XP-A6361, produced by Momentive Performance Materials Inc.) was coated.

Thereafter, silicone rubber (XE15-C2038, manufactured by Momentive Performance Materials Inc.) was injected between the polyimide resin pipe-shaped material and the tube of fluorine resin.

Then, primary vulcanization was carried out at 150° C. for 30 minutes and further, post vulcanization was carried out at 200° C. for 4 hours to obtain a pipe-shaped material in which silicone rubber of a thickness of 200 μm was formed on the outer layer of a polyimide pipe-shaped material. The hardness of the rubber layer was 26 degrees (JIS-A).

Subsequently, a polyimide resin pipe-shaped material was released from the stainless steel pipe after cooling, and targeted heat-producing elements S-A through S-N and C-A through C-N were obtained. a thickness of the heat-producing element was about 380 μm.

### Performance Evaluation

A heat-producing elements S-A through S-N and C-A through C-N were mounted in a fixing device having the constitution shown in FIG. 2, and the fixing device was installed in the image forming apparatus shown FIG. 3, then 500,000 sheets of A4 size image support were let pass through, with 5-minute intermittence per 10,000 sheets, and conditions of the heat-producing element were observed.

Results of the specific resistance, heat-up performance, fixing performance, oxidation of electrically-conductive fiber are shown in Tables 3 and 4.

### (Specific Volume Resistance)

The specific volume resistance of the heat-producing element can be obtained by the following formula.

Specific volume resistance (ρ)=(R·d·W)/L(Ω·m)

(herein, resistance value (R: Ω), thickness of the heat-producing layer (d: m), length in circumferential direction (W: m), length between the electrodes (L: m))

The specific volume resistance of not less than 1×10⁻⁶Ω·m is described as “∞”.

### (Heat-Up Performance)

For evaluating the heat-up performance, temperature was measured by applying 10 V for 5 minutes via a thermo-viewer.

A: 16° C./sec or higher, extremely superior.
B: Not more than 16° C./sec and more than 4° C./S, practically acceptable.
C: Not more than 4° C./sec, practically unacceptable.

### (Fixing Performance)

Fixing performance shows a degree of toner fixing strength of toner image which is formed by employing powder toner, transferred to an image support and thermally fixed via a heat-producing element.

Fixing performance was determined by transferred toner to cotton cloth when a cotton cloth pad is pressed and rubbed on the black toner solid image and observation of image state at folded portion when the toner solid image is folded 10 times hardly.

A: No problem even rubbed or folded.
B: Cotton cloth pad stained slightly when rubbed, but practically acceptable.
C: Cotton cloth pad stained when rubbed, toner released at the folding portion and practically unacceptable.

### (Oxidation)

Oxidation was evaluated by oxidized condition of an electrically-conductive fiber within a heat-producing element by observing via industrial optical microscope at 500 times magnification after passing 500,000 sheets.

A: Not oxidize.
B: Slightly oxidized.
C: Fairly oxidized.

TABLE 3

| | | | Heat-up | | | | |
|---|---|---|---|---|---|---|---|
| Heat- | | Specific | Performance | | | | |
| producing | Fiber | Resistance | (applying 10 V) | | Fixing | | |
| element | No. | (Ω · m) | Rate (° C./S) | | Performance | Oxidation | Remarks |
| S-A | 1 | 8.0 × 10⁻⁵ | 16.0 | A | B | B | Invention |
| S-B | 2 | 5.0 × 10⁻⁴ | 18.0 | A | B | B | Invention |
| S-C | 3 | 7.0 × 10⁻⁵ | 19.0 | A | B | B | Invention |
| S-D | 4 | 5.0 × 10⁻⁴ | 20.0 | A | B | B | Invention |
| S-E | 5 | 1.3 × 10⁻⁴ | 22.0 | A | B | B | Invention |
| S-F | 6 | 2.1 × 10⁻⁴ | 30.0 | A | B | B | Invention |
| S-G | 7 | 4.0 × 10⁻⁴ | 23.0 | A | B | B | Invention |
| S-H | 8 | 6.0 × 10⁻⁵ | 40.0 | A | B | B | Invention |
| S-I | 9 | ∞ | 0.01 | C | C | C | Comparative |
| S-J | 10 | 9.0 × 10⁻⁴ | 4.0 | C | C | C | Comparative |
| S-K | 11 | 4.0 × 10⁻⁵ | 35.0 | A | C | B | Comparative |
| S-L | 12 | ∞ | 0.01 | C | C | C | Comparative |
| S-M | 13 | 1.4 × 10⁻⁴ | 23.0 | A | C | B | Comparative |
| S-N | 14 | 2.0 × 10⁻⁵ | 45.0 | A | C | C | Comparative |

TABLE 4

| | | | Heat-up | | | | |
|---|---|---|---|---|---|---|---|
| Heat- | | Specific | Performance | | | | |
| producing | Fiber | resistance | (applying 10 V) | | Fixing | | |
| element | No. | (Ω · m) | Rate (° C./S) | | Performance | Oxidation | Remarks |
| C-A | 1 | 5.0 × 10⁻⁴ | 6.0 | B | B | B | Invention |
| C-B | 2 | 3.0 × 10⁻⁴ | 6.0 | B | B | B | Invention |
| C-C | 3 | 1.0 × 10⁻⁴ | 7.0 | B | B | B | Invention |
| C-D | 4 | 2.9 × 10⁻⁵ | 8.0 | B | B | B | Invention |
| C-E | 5 | 1.3 × 10⁻⁴ | 10.0 | B | B | B | Invention |
| C-F | 6 | 1.4 × 10⁻⁴ | 13.0 | B | B | B | Invention |
| C-G | 7 | 1.3 × 10⁻⁴ | 13.0 | B | B | B | Invention |
| C-H | 8 | 1.1 × 10⁻⁴ | 12.0 | B | B | B | Invention |
| C-I | 9 | 8.7 × 10⁻⁴ | 2.6 | C | C | B | Comparative |
| C-J | 10 | 8.2 × 10⁻⁵ | 13.0 | B | C | B | Comparative |
| C-K | 11 | 2.3 × 10⁻⁴ | 3.0 | C | C | B | Comparative |
| C-L | 12 | 5.1 × 10⁻⁴ | 2.0 | C | C | B | Comparative |
| C-M | 13 | 2.6 × 10⁻³ | 0.1 | C | C | B | Comparative |
| C-N | 14 | 9.0 × 10⁻⁴ | 4.0 | C | C | B | Comparative |

The evaluation results shown in Tables 3 and 4 clearly show that every performance of S-A through S-H and C-A through C-H is excellent but S-I through S-N and C-I through C-N out of the present invention are problematic because of high resistivity and with respect to at least any one of the characteristics of heat-up performance, fixing performance and oxidation.

1. A heat-producing element for fixing a toner image on an image support, wherein the heat-producing element comprises a heat-resistant resin and electrically-conductive fiber having a shape stipulated by conditions 1, 2 and 3.
1. Aspect ratio: 0.025≦(A/B)≦0.25
2. Diameter of electrically-conductive fiber (A): 0.5 μm≦A≦3 0 μm
3. Length of electrically-conductive fiber (B): 5.0 μm≦B≦1,000 μm

2. The heat-producing element of claim 1, wherein the heat-resistant resin comprises a polyimide resin.

3. The heat-producing element of claim 1, wherein the electrically-conductive fiber is metallic fiber and the heat-resistant resin is a polyimide resin.

4. The heat-producing element of claim 1, wherein the electrically-conductive fiber is fiber of graphite and the heat-resistant resin is a polyimide resin.

5. The heat-producing element of claim 2, wherein a content of the electrically-conductive fiber is from 5.0% to 60% by volume with respect to the polyimide resin.

6. The heat-producing element of claim 1, wherein the aspect ratio is 0.04 to 0.23.

7. The heat-producing element of claim 2, wherein a thickness of the heat-producing element as a whole is 200 to 600 μm.

8. A heat-producing element for fixing a toner image on an image support comprising a heat-resistant resin support and, provided thereon, a heat-producing layer, wherein the heat-producing layer comprises a heat-resistant resin and electrically-conductive fiber having a shape stipulated by conditions 1, 2 and 3.
1. Aspect ratio: 0.025≦(A/B)≦0.25
2. Diameter of electrically-conductive fiber (A): 0.5 μm≦A≦3 0 μm
3. Length of electrically-conductive fiber (B): 5.0 μm≦B≦1,000 μm

9. The heat-producing element of claim 8, which further comprises an insulating layer on the heat-producing layer.

10. The heat-producing element of claim 8, which further comprises an elastic layer on the heat-producing layer.

11. The heat-producing element of claim 10, which further comprises a releasing layer on the elastic layer.

12. A toner image forming apparatus comprising an electrophotographic photoreceptor for forming a static latent image, a developing device developing the latent image to form a toner image on the photoreceptor, a transfer device transferring the toner image to an image support and a fixing device fixing the toner image on the image support, wherein the fixing device comprises heat-producing element of claim 1.
